(19) United States
(12) Patent Application Publication
(10) Pub. No.: US 2024/0331042 A1
(43) Pub. Date: Oct. 3, 2024

(54) SYSTEMS AND METHODS FOR SHARING FINANCIAL PROFILES

(71) Applicant: Wells Fargo Bank, N.A., San Francisco, CA (US)

(72) Inventors: Cecil B. Burrowes, Charlotte, NC (US); Debashis Ghosh, Charlotte, NC (US); Lynne Sanders, Charlotte, NC (US); Carrie Anne Hanson, Charlotte, NC (US)

(21) Appl. No.: 18/190,759

(22) Filed: Mar. 27, 2023

(51) Int. Cl. G06Q 40/06

(52) U.S. Cl. CPC G06Q 40/06

(57) ABSTRACT

Systems, apparatuses, methods, and computer program products are disclosed for sharing financial profiles. An example method includes determining, by a financial profile identification engine, a financial footprint of an individual and analyzing, by a financial profile analysis engine, the financial footprint of the individual to identify a financial data conflict between the first set of financial data and the second set of financial data. The example method further includes determining, by the financial profile analysis engine, one or more actions to resolve the financial data conflict and generating, by secure data circuitry, a secured financial update dataset based on a conflict response. The example method further includes transmitting, by communications hardware, the secured financial update dataset to one or more of the first financial institution and the second financial institution.

### BACKGROUND

An individual may have one or more accounts with one or more entities. An individual may change or update information regarding one of their accounts. However, propagating these changes to additional accounts poses significant challenges for individuals and entities, particularly when the accounts are spread across different institutions and managed differently.

### BRIEF SUMMARY

As discussed above, an individual may update information (e.g., demographic information, beneficiary information, security information, or the like) associated with their financial accounts. In doing so, the individual may need to update multiple accounts (or all of their accounts) at a variety of different institutions. As one example, if the individual recently moved, the individual may need to update their address in connection with all of their accounts. However, manually propagating updated information for multiple financial accounts across multiple financial institutions (hereinafter referred to as an individual's financial footprint) is often an inefficient and time-consuming process. In this regard, numerous manual actions are often required.

For instance, the individual may need to update information one financial institution at a time. For example, assume an individual has two financial accounts, a first financial account at financial institution A and a second financial account at financial institution B. The individual may first need to visit financial institution A's website to update information for the first account and then need to visit financial institution B's website to update information for the second account at a later time. In some cases, an individual may need to phone the financial institution or appear in person (e.g., at a local branch) to update certain information, further complicating the process.

This manual process may become increasingly more difficult with a larger financial footprint (e.g., more financial accounts associated with more financial institutions). For example, an input error may be more likely to occur if an individual must sequentially update information associated with their financial footprint one financial account at a time. An input error may be a typographical error (e.g., a spelling error, inputting information in the wrong section, etc. or the like. Moreover, if the individual possesses a large number of accounts, it may be easy for the individual to forget about certain accounts and thus not update those accounts accordingly.

Example embodiments described herein mitigate issues posed by manually updating information associated with an individual's financial profile by sharing financial profiles (e.g., financial accounts associated with particular financial institutions). Example embodiments may determine a financial footprint of an individual. For example, example embodiments may retrieve a first set of financial data about the individual from a first financial institution and a second set of financial data about the individual from a second financial institution to determine a financial footprint associated with an individual. In addition, example embodiments may analyze the financial footprint of the individual to identify a financial data conflict between the first set of financial data and the second set of financial data. For example, example embodiments may identify a discrepancy in the marital status listed in the first and second sets of financial data.

Example embodiments may also determine one or more actions to resolve the financial data conflict. In addition, example embodiments may cause presentation of one or more actions to resolve the one or more financial data conflicts. Example embodiments may receive a conflict response describing how to resolve the one or more financial data conflicts. In addition, example embodiments may cause presentation of the one or more actions on a trusted device associated with the individual.

Example embodiments may also transmit a data aggregation request to collect data about an individual from one or more financial institutions. In some embodiments, the data aggregation request may indicate the individual (e.g., via an individual identifier), additional verification information (e.g., a digital signature, or the like), and/or the like such that the particular data aggregation request is uniquely configured for a particular financial institution. Furthermore, example embodiments may generate a secured financial update dataset that describes a conflict response based on an update to the first set of financial data or the second set of financial data. In some embodiments, the secured financial update dataset is masked. For example, the secured financial update dataset may be generated such that a portion of the data in the conflict response is masked or otherwise omitted.

Accordingly, the present disclosure sets forth systems, methods, and apparatuses for sharing financial profiles. Through sharing financial profiles, example embodiments mitigate the risk, time consumption, and computational resource consumption involved in manually updating information associated with an individual's financial profile. Implementation of certain embodiments is also enhanced by the flexibility of the solution. For example, the financial data conflict may be identified based on a user request to generate a financial footprint (hereinafter referred to as a financial footprint request) and/or the financial data conflict may be identified in response to a trigger initiating the financial footprint request enabling a more passive method for identifying financial data conflicts.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for sharing financial profiles, in accordance with some example embodiments described herein.

FIG. 4 illustrates an example flowchart for aggregating a plurality of financial data associated with one or more financial institutions, in accordance with some example embodiments described herein.

FIG. 5 illustrates an example flowchart for identifying additional required actions based on historical data, in accordance with some example embodiments described herein.

FIG. 6 illustrates an example flowchart for receiving a conflict response, in accordance with some example embodiments described herein.

FIG. 7 illustrates a swim lane diagram with example operations that may be performed by components of the environment depicted in FIG. 1, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “financial footprint” refers to a data structure that comprises data pertaining to financial profiles associated with an individual at multiple financial institutions. In some embodiments, the financial footprint may comprise of a particular subset of data of various financial profiles associated with the financial institutions. For example, a financial footprint may be generated to only contain beneficiary information of the various financial profiles. Said another way, the financial footprint may not include all information associated with an individual but rather include only a particular subset of data regarding the financial profiles. Alternatively, in some embodiments, a financial footprint may comprise all data associated with an individual in connection with their various financial profiles.

The term “first set of financial data” refers to a set of data associated with an individual originating from a first financial institution. In some embodiments, a first set of financial data associated with an individual originating from a first financial institution may describe demographic data about the individual, beneficiary data, or the like.

The term “second set of financial data” refers to a set of data associated with an individual originating from a second financial institution. In some embodiments, a second set of financial data associated with an individual originating from a second financial institution may describe demographic data about the individual, beneficiary data, or the like.

The term “financial data conflict” refers to one or more inconsistencies in data included in the financial footprint. In some embodiments, a financial data conflict may include a singular inconsistency (e.g., a difference in an address listed in a first set of financial data and a second set of financial data) or a plurality of inconsistencies. For example, an entirety of data included in a first set of financial data may be inconsistent with the data included in a second set of financial data.

The term “secured financial update dataset” refers to data describing a conflict response based on an update to the first set of financial data or the second set of financial data. In some embodiments, the secured financial update dataset is masked. For example, the secured financial update dataset may be generated such that a portion of the data in the conflict response is masked, obscured, or otherwise omitted. In some embodiments, the secured financial update dataset may also be formatted or configured in accordance with a particular financial institution.

The term “financial footprint request” refers to an electronic request from an individual (e.g., an individual's user device) that initiates a collection and aggregation of data about an individual from one or more financial institutions. The financial footprint request may indicate the name of an individual, individual identifier, and/or the like such that the particular individual requesting the financial footprint request is uniquely identifiable. In some embodiments, the financial footprint request may specify particular identifiers of financial institutions to collect data from. In some embodiments, the financial footprint request may specify an aggregation of data from all financial instructions associated with the individual. In some embodiments, the financial footprint request may be received from a user device via a network in response to a manual user request or an automatic trigger event. An automatic trigger event may include a temporal trigger event, a circumstantial trigger event, and/or the like. A temporal trigger event may take place based on rules and/or configurations that require a financial footprint request to be generated within a particular time period or at a particular point in time. A circumstantial trigger event may take place based on rules and/or configurations that require that a financial footprint request be generated in response to a set of conditions and/or criteria being met.

The term “data aggregation request” refers to an electronic request to collect data about an individual from a financial institution. The data aggregation request may indicate the individual (e.g., via an individual identifier), and additionally include verification information (e.g., a digital signature, or the like), and/or the like such that the particular data aggregation request is uniquely configured to be processed by a particular financial institution. In some embodiments, the data aggregation request may specify to aggregate a particular subset of data associated with the individual (e.g., marital status). Alternatively, the data aggregation request may specify to aggregate (e.g., collect) all data associated with the individual from the financial instruction.

As used herein, the term “historical data” refers to data that describes previously resolved financial data conflicts. In some embodiments, historical data may include a previous financial data conflict and the one or more actions that resolved the financial data conflict, an indication of the individual associated with the financial data conflict, or the like. In some embodiments, historical data may also include additional required actions and additional optional action in response to the resolution of the financial data conflict (e.g., the previously executed one or more actions). For example, data indicating a change in marital status may have lead to performing additional optional actions, such as modifying additional data (e.g., a last name or address), may be included in historical data.

The term “conflict response” refers to a data structure that describes the one or more actions to resolve a financial data conflict. In some embodiments, the conflict response may include a digital signature originating from a trusted device, a biometric marker, and/or the like. In some embodiments, the conflict response may be formatted based on the particular financial institution receiving the conflict response (e.g., in a preferred format for processing by the particular financial institution). The conflict response may include a one or more actions associated with the financial data conflict. In some embodiments, the conflict response may include one or more actions associated with one or more additional required actions and/or one or more additional optional actions.

The term “financial profile update report” refers to a data structure that indicates a receipt for an executed conflict response. The financial profile update report may be customized to suit a particular style desired by an individual. In some embodiments, the financial profile update report may be generated according to a formatted output, for example, as a webpage comprising visual representations of any changes to the individual's financial profiles associated with a financial institution. In some embodiments, the financial profile update report may be a message transmitted to the individual as a receipt or notification documenting the conflict response.

### System Architecture

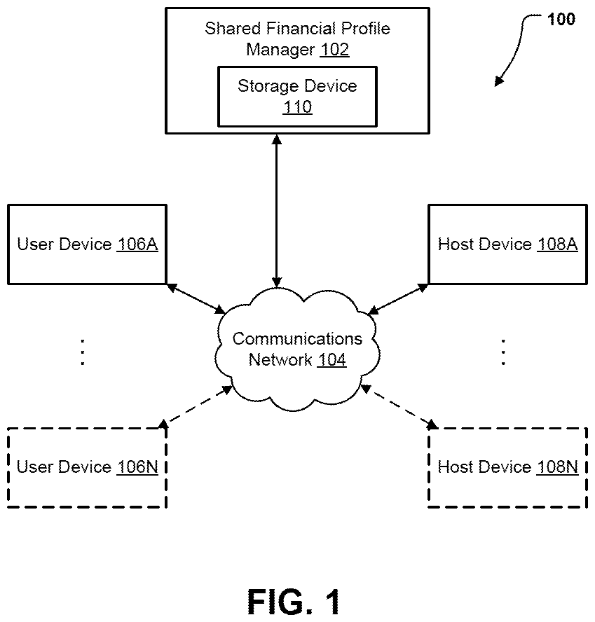

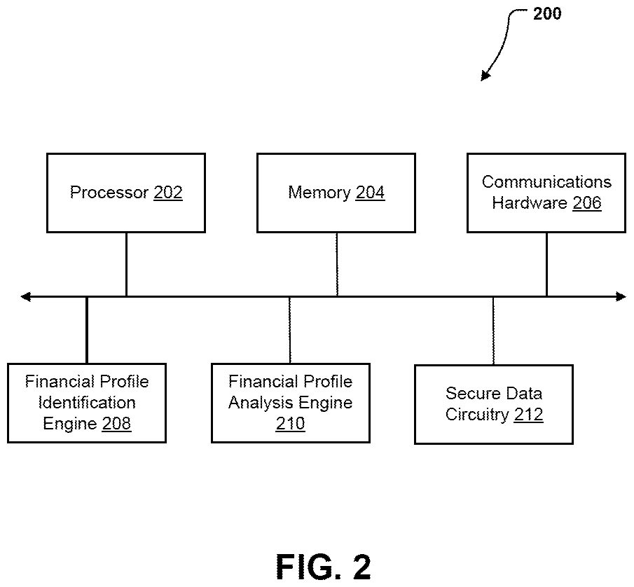

Example embodiments described herein may be implemented using any of a variety of computing devices or servers. To this end, FIG. 1 illustrates an example environment 100 within which various embodiments may operate. As illustrated, a shared financial profile manager 102 may receive and/or transmit information via communications network 104 (e.g., the Internet) with any number of other devices, such as one or more of user devices 106A-106N and/or host devices 108A-108N. The shared financial profile manager 102 may be implemented as one or more computing devices or servers, which may be composed of a series of components. Particular components of the shared financial profile manager 102 are described in greater detail below with reference to apparatus 200 in connection with FIG. 2.

In some embodiments, the shared financial profile manager 102 further includes a storage device 110 that comprises a distinct component from other components of the shared financial profile manager 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the shared financial profile manager 102. Storage device 110 may store information relied upon during operation of the shared financial profile manager 102, such as various algorithms that may be used by the shared financial profile manager 102, data and documents to be analyzed using the shared financial profile manager 102, or the like. In addition, storage device 110 may store control signals, device characteristics, and access credentials enabling interaction between the shared financial profile manager 102 and one or more of the user devices 106A-106N or host devices 108A-108N.

The user devices 106A-106N may be embodied by any host devices known in the art, such as such as desktop or laptop computers, smartphones, or the like. Similarly, host devices 108A-108N may be embodied by any host devices known in the art, such as desktop or laptop computers, or the like that are managed by particular financial institutions. For example, financial institution A may manage host device 108A, financial institution B may manage host device 108B, or the like. User devices 106A-106N and host devices 108A-108N need not themselves be independent devices, but may be peripheral devices communicatively coupled to other computing devices.

Although FIG. 1 illustrates an environment and implementation in which the shared financial profile manager 102 interacts indirectly with a user via one or more of user devices 106A-106N and/or host devices 108A-108N, in some embodiments users may directly interact with the shared financial profile manager 102 (e.g., via communications hardware of the shared financial profile manager 102), in which case separate user devices 106A-106N and/or host devices 108A-108N may not be utilized. Whether by way of direct interaction or indirect interaction via another device, a user may communicate with, operate, control, modify, or otherwise interact with the shared financial profile manager 102 to perform the various functions and achieve the various benefits described herein.

### Example Implementing Apparatuses

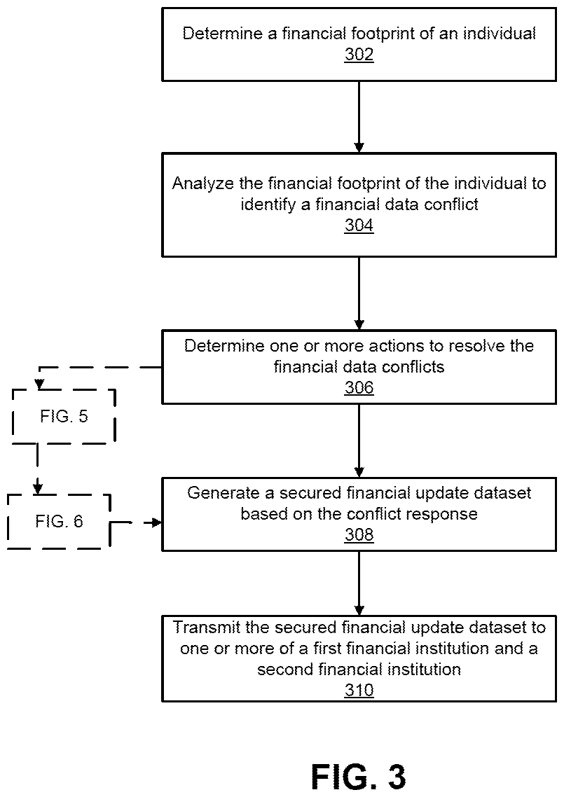

The shared financial profile manager 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-5. As illustrated in FIG. 2, the apparatus 200 may include processor 202, memory 204, communications hardware 206, a financial profile identification engine 208, a financial profile analysis engine 210, and secure data circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a financial profile identification engine 208 that determines a financial footprint of an individual. The financial profile identification engine 208 may utilize processor 202, memory 204, or any other hardware component included in the apparatus 200 to perform these operations, as described in connection with FIGS. 3-5 below. The financial profile identification engine 208 may further utilize communications hardware 206 to gather data from a variety of sources (e.g., user devices 106A-106N or host devices 108A-108N, as shown in FIG. 1), and/or exchange data with a user, and in some embodiments may utilize processor 202 and/or memory 204 to perform any or more of the above operations.

In addition, the apparatus 200 further comprises a financial profile analysis engine 210 that analyzes a financial footprint of an individual to identify a financial data conflict between a first set of financial data and a second set of financial data and determines one or more actions to resolve the financial data conflict. The financial profile analysis engine 210 may utilize processor 202, memory 204, or any other hardware component included in the apparatus 200 to perform these operations, as described in connection with FIGS. 3-5 below. The financial profile analysis engine 210 may further utilize communications hardware 206 to gather data from a variety of sources (e.g., user devices 106A-106N or host devices 108A-108N, as shown in FIG. 1), and/or exchange data with a user, and in some embodiments may utilize processor 202 and/or memory 204 to perform any or more of the above operations.

Further, the apparatus 200 further comprises a secure data circuitry 212 that generates a secured financial update dataset based on a conflict response. The secure data circuitry 212 may utilize processor 202, memory 204, or any other hardware component included in the apparatus 200 to perform these operations, as described in connection with FIGS. 3-5 below. The secure data circuitry 212 may further utilize communications hardware 206 to gather data from a variety of sources (e.g., user devices 106A-106N or host devices 108A-108N, as shown in FIG. 1), and/or exchange data with a user, and in some embodiments may utilize processor 202 and/or memory 204 to perform any or more of the above operations.

Although components 202-212 are described in part using functional language, it will be understood that the particular implementations necessarily include the use of particular hardware. It should also be understood that certain of these components 202-212 may include similar or common hardware. For example, the financial profile identification engine 208, financial profile analysis engine 210, and secure data circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the financial profile identification engine 208, financial profile analysis engine 210, and secure data circuitry 212 may leverage processor 202, memory 204, or communications hardware 206 as described above, it will be understood that any of financial profile identification engine 208, financial profile analysis engine 210, and secure data circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that financial profile identification engine 208, financial profile analysis engine 210, and secure data circuitry 212 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by the shared financial profile manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, financial profile identification engine 208, financial profile analysis engine 210, secure data circuitry 212, and/or any combination thereof. It will be understood that user interaction with the shared financial profile manager 102 may occur directly via communications hardware 206, or may instead be facilitated by a separate user device 106A-106N, as shown in FIG. 1, and which may have similar or equivalent physical componentry facilitating such user interaction.

Turning first to FIG. 3, example operations are shown for sharing financial profiles.

As shown by operation 302, the apparatus 200 includes means, such as processor 202, memory 204, financial profile identification engine 208, or the like, for determining a financial footprint of an individual. A financial footprint may comprise data pertaining to financial profiles associated with an individual at one or more financial institutions. For example, assume an individual has two financial accounts, a first financial account at a first financial institution and a second financial account at a second financial institution. In this example, the financial footprint associated with the individual may include data associated with the first financial account at the first financial institution and data associated with the second financial account at the second financial institution. In some embodiments, the financial footprint may comprise a particular subset of data of the financial profiles associated with the one or more financial institutions. For example, a financial footprint may be generated to only contain beneficiary information of the various financial profiles. Said another way, the financial footprint may not include all information associated with an individual but rather include only a particular subset of data regarding the financial profiles. Alternatively, in some embodiments, a financial footprint may comprise all data associated with an individual in connection with their various financial profiles.

In some embodiments, the financial footprint may include at least a first set of financial data from a first financial institution and a second set of financial data from a second financial institution. The first set of financial data may comprise a set of data associated with an individual originating from a first financial institution. In some embodiments, a first set of financial data associated with an individual originating from a first financial institution may comprise demographic data about the individual, beneficiary data, and/or the like (e.g., data that the individual has provided to the first financial institution or is otherwise known to the second financial institution). In some embodiments, the second set of financial data may comprise a set of data associated with an individual originating from a second financial institution. In some embodiments, a second set of financial data associated with an individual originating from a second financial institution may comprise demographic data about the individual, beneficiary data, and/or the like (e.g., data that the individual has provided to the second financial institution or is otherwise known to the second financial institution). Though example embodiments discuss the use of first and second sets of financial data, it is to be appreciated that in some embodiments, additional sets of financial data (e.g., originating from additional financial institutions) may also be included in a financial footprint of an individual.

In some embodiments, financial profile identification engine 208 may retrieve the first set of financial data about the individual and the second set of financial data about the individual from a local storage device (e.g., storage device 110, memory 204, or the like). The financial profile identification engine 208 may utilize any suitable technique to identify data from the first set of financial data and second set of financial data to include in the financial footprint about an individual, such as optical character recognition (OCR), natural language processing (NLP), searching algorithms, machine learning models, and/or the like. For example, financial profile identification engine 208 may utilize OCR on any data in the first set of financial data and second set of financial data if needed, and then search for an indicator of particular data to include in the financial footprint (hereinafter referred to as financial footprint data). For example, the financial profile identification engine 208 may search for the term “beneficiary” associated with the first set of financial data and second set of financial data, which may act as an identifier to identify the names and social security numbers of beneficiaries associated with the first set of financial data and the second set of financial data.

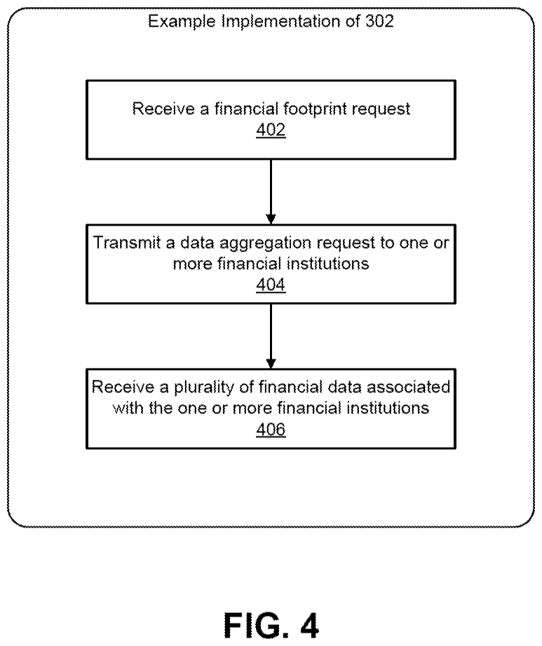

In some embodiments, financial profile identification engine 208 may not readily have access to the first set of financial data and the second set of financial data from a first financial institution and second financial institution (e.g., due to a lack of data, aged data, or the like) and may need to retrieve the first and second sets of financial data from the first financial institution and the second financial institution to determine a financial footprint of the individual. Turning now to FIG. 4, example operations are shown for aggregating a plurality of financial data associated with one or more financial institutions to generate a financial footprint for an individual.

As shown by operation 402, the apparatus 200 includes means, such as processor 202, memory 204, communications hardware 206, or the like for receiving a financial footprint request. A financial footprint request may comprise an electronic request to initiate an aggregation of financial footprint data about an individual from one or more financial institutions. The financial footprint request may indicate the individual (e.g., via an individual identifier) such that the particular individual requesting the financial footprint request is uniquely identifiable. In some embodiments, the financial footprint request may specify particular financial institutions to collect financial footprint data from. Alternatively, the financial footprint request may specify to aggregate data from all financial instructions associated with the individual.

The financial footprint request may be received from one or more user devices and/or a system device in response to a transmission of a financial footprint request or an automatic trigger event. For example, an individual, via their user device 106A, may transmit a financial footprint request via a network (communications network 104, FIG. 1) to the apparatus 200 (e.g., communications hardware 206). In some embodiments, the financial footprint request may be transmitted from a computing device to the apparatus 200 in response to an automatic trigger event.

In some embodiments, an automatic trigger event may include a temporal trigger event or a circumstantial trigger event. A temporal trigger event may describe rules and/or configurations that require a financial footprint request to be generated within a particular time period or at a particular point in time. For example, assume a temporal trigger event is configured to transmit a financial footprint request from user device 106A on the first of the month. Therefore, every first of the month the temporal trigger event may be activated and transmit a financial footprint request from user device 106A to the apparatus 200 via a network. A circumstantial trigger event may describe rules and/or configurations that require a financial footprint request be generated in response to a set of conditions and/or criteria being met. In some embodiments, a financial institution, an individual, or the like may compile a set of financial footprint rules that describes conditions that must be met to activate a circumstantial trigger. For example, the set of financial footprint rules may require a financial footprint request be transmitted from a computing device (e.g., user device 106A, user device 106N, or the like) in an instance in which the individual adds or changes data associated with one or more financial institutions. For instance, circumstantial trigger event may comprise the individual updating address information at a first financial institution, which would then cause a financial footprint request to be transmitted to the apparatus 200.

As shown by operation 404, the apparatus 200 includes means, such as processor 202, memory 204, communications hardware 206, or the like for transmitting a data aggregation request to one or more financial institutions. As discussed above, a data aggregation request comprises an electronic request to collect data about an individual from a financial institution. The data aggregation request may indicate the individual (e.g., via an individual identifier), and additionally include verification information (e.g., a digital signature, or the like), and/or the like such that the particular data aggregation request is uniquely configured to be processed by a particular financial institution. In some embodiments, the data aggregation request may specify to aggregate a particular subset of data associated with the individual (e.g., marital status). Alternatively, the data aggregation request may specify to aggregate (e.g., collect) all data associated with the individual from the financial instruction.

In some embodiments, the data aggregation request may be transmitted by communications hardware 206 in response to reception of a financial footprint request. For example, if a financial footprint associated with an individual is aged (e.g., financial footprint data has not been collected for a period of time) or there is a lack of data, communications hardware 206 may be triggered to transmit a data aggregation request. In some embodiments, the data aggregation request may be transmitted to retrieve recent data about an individual. For example, the financial footprint request may be transmitted by an individual if the individual desires the most updated data pertaining to their financial footprint such that the apparatus 200 does not search a storage device (e.g., storage device 110) for financial footprint data about an individual, but rather transmits a data aggregation request to financial institution(s) to retrieve one or more sets of financial data about the individual.

In some embodiments, communications hardware 206 may transmit the data aggregation request via a network (communications network 104, FIG. 1) to one or more financial institutions (e.g., host device 108A, host device 108N, or the like). In some embodiments, communications hardware 206 may search a storage device (e.g., memory 204, storage device 110, or the like) for a data aggregation request blueprint. The data aggregation request blueprint may indicate the necessary data, formatting, and/or predefined information request that may be required to access data from a particular financial institution. For example, each financial institution may have their own set of protocols or rules that govern the collection of data from their repositories. Certain financial institutions may utilize their own Application Programming Interfaces (APIs) which a data aggregation request must adhere to in order to successfully retrieve data from the financial institution. The communications hardware 206 may then transmit a data aggregation request that is formatted according to the data aggregation request blueprint associated with the one or more financial institutions.

As shown by operation 406, the apparatus 200 includes means, such as processor 202, memory 204, communications hardware 206, financial profile analysis engine 210, or the like, for receiving a plurality of financial data associated with the one or more financial institutions. In some embodiments, the plurality of financial data may include a first set of financial data about the individual from a first financial institution (e.g., in response to a data aggregation request sent to the first institution) and the second set of financial data about the individual from a second financial institution (e.g., in response to a data aggregation request sent to the second institution). In some embodiments, the plurality of financial data may be received from a host device (e.g., host device 108A-108N, or the like) and transmitted to the apparatus 200 (e.g., communications hardware 206) via a network (e.g., communications network 104, FIG. 1).

In some embodiments, the communications hardware 206 may store the received plurality of financial data in a storage device (e.g., memory 204, storage device 110, or the like). In some embodiments, financial profile analysis engine 210 may modify or preprocess the received plurality of financial data prior to storing the plurality of financial data in a storage device. For example, financial profile analysis engine 210 may convert the received plurality of financial data to a specific format such that the data can be stored in a database that includes financial data associated with a particular individual. In some embodiments, the database may store the plurality of financial data and the one or more financial institutions associated with the plurality of financial data in the form of key-value pairs where the key portion specifies a financial institution where the financial data originates, and the value portion specifies the financial data associated with the financial institution.

Returning to FIG. 3, as shown by operation 304, the apparatus 200 includes means, such as processor 202, memory 204, financial profile analysis engine 210, or the like, for analyzing the financial footprint of the individual to identify a financial data conflict. A financial data conflict may comprise an inconsistency among financial footprint data included in the financial footprint. In some embodiments, the inconsistency in financial footprint data may involve a difference in a first set of financial data and a second set of financial data. In some embodiments, a financial data conflict may include a singular financial data conflict. For example, if the first set of financial data indicates a marital status of married and a second set of financial data indicates a marital status of single, the mismatch in marital status may be identified as a financial data conflict. In some embodiments, a financial data conflict may include a plurality of financial data conflicts. For example, a financial data conflict may describe that multiple data points or even the entirety of the data included in the first set of financial data is inconsistent with the second set of financial data.

In some embodiments, the financial profile analysis engine 210 may reference metadata to infer which set of financial data includes the incorrect financial footprint data. Continuing with the above example in which there is a financial data conflict associated with marital status, the financial profile analysis engine 210 may identify that the first set of financial data is more recent than the second set of financial data. In some embodiments, financial profile analysis engine 210 may then determine that the first set of financial data is correct while the second set of financial data is incorrect.

In some embodiments, the financial profile analysis engine 210 may retrieve the financial footprint about the individual that includes the first set of financial data and the second set of financial data from a storage device (e.g., memory 204, storage device 110, or the like) to compare the two data sets. The financial footprint may be stored as a data structure (e.g., a table or the like) in the form of key-value pairs where the key specifies a financial institution associated with the individual and the value specifies a type of financial footprint data (e.g., married, specified primary beneficiary, an address, or the like).

In some embodiments, financial profile analysis engine 210 may leverage a financial conflict model to process the financial footprint data to identify financial data conflicts. In some embodiments, the financial conflict model may be a rules-based model that references a set of financial conflict rules that describe the conditions to identify a financial data conflict included in a financial footprint. In some embodiments, the set of financial conflict rules may describe the conditions associated with each type of financial footprint data included in a financial footprint to identify a financial data conflict. For example, the financial conflict model may iteratively reference the financial data conflict rules for each key (e.g., financial institution) included in the financial footprint data and output one or more identified financial data conflicts. As another example, the financial conflict model may identify the beneficiary data in the first set of financial data and the second set of financial data. The financial conflict model may reference the set of financial conflict rules that may recite that beneficiary data associated with the same account type (e.g., checking, brokerage, saving, or the like) must have the same beneficiary listed to avoid a financial data conflict. If the beneficiary data included in the first set of financial data and second set of financial data do not match for the same account type (or if beneficiary is missing in one set of financial data), the financial conflict model may output a financial conflict that describes the inconsistency in beneficiary data across the first set of financial data and the second set of financial data.

As shown by operation 306, the apparatus 200 includes means, such as processor 202, memory 204, communications hardware 206, financial profile analysis engine 210, or the like, for determining one or more actions to resolve the financial data conflicts. In some embodiments, one or more actions may a suggested action for an individual or financial institution to take with regards to a financial data conflict. In some embodiments, an action may be any requested operation that resolves one or more financial data conflicts. Some example one or more actions include adding or modifying data, such as demographic data (e.g., marital status, name, kids, income, employment status, or the like), beneficiary information, or the like.

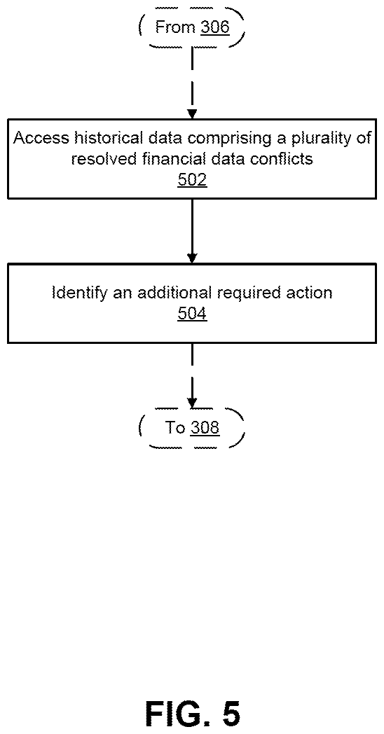

In some embodiments, financial profile analysis engine 210 may determine the one or more actions by accessing stored data in a storage device (e.g., memory 204, storage device 110, or the like), which is described below in relation to FIG. 5. Turning now to FIG. 5, example operations are shown for identifying one or more actions to resolve a financial data conflict.

As shown by operation 502, the apparatus 200 includes means, such as processor 202, memory 204, communications hardware 206, financial profile identification engine 208 or the like, for accessing historical data comprising a plurality of resolved financial conflicts. In some embodiments historical data may comprise previously resolved financial data conflicts. In some embodiments, the previous resolved financial data conflicts may include financial data conflicts and the one or more actions that resolved the financial data conflicts, the individual associated with the financial data conflicts, or the like.

In some embodiments, financial profile identification engine 208 may cause communications hardware 206 to transmit a request for historical data (hereinafter referred to as a historical data request). For example, financial profile identification engine 208 may cause communications hardware 206 to transmit a historical data request via a network (e.g., communications network 104, FIG. 1) to a data repository. In some embodiments, a historical data request may be transmitted to a computing device associated with a financial institution (e.g., host device 108A, host device 108N, or the like). The historical data request may indicate the financial data conflict, the individual associated with the financial data conflict, and/or the like such that the apparatus 200 (e.g., communications hardware 206) gains access to a data repository comprising historical data.

In some embodiments the financial profile identification engine 208 may search a local storage device (e.g., memory 204, storage device 110, or the like) for historical data. More specifically, financial profile identification engine 208 may search a database for historical data associated with the financial data conflict. In some embodiments, financial profile identification engine 208 may search the database for historical data with the same financial data conflict. For example, the database may store historical data in the form of key-value pairs where the key specifies a financial data conflict, and the value specifies the one or more actions to resolve the financial data conflict.

In some embodiments the financial profile identification engine 208 may reference data pertaining to the financial data conflict (e.g., metadata) to determine which historical data to retrieve from a storage device. In some embodiments, the financial data conflict may include information relating to the financial institution associated with the financial data conflict, demographic data about the individual associated with the financial data conflict, and/or the like. In some embodiments, the financial profile identification engine 208 may leverage a model to execute a filtering operation on the historical data to identify historical data relevant to the financial data conflict. For example, the historical data and the financial data conflict associated with the individual may be input to the model and the model may filter out financial conflicts included in the historical data that do not include the same financial institution as the financial data conflict associated with the individual.

As shown by operation 504, the apparatus 200 includes means, such as memory 204, communications hardware 206, financial profile analysis engine 210 or the like, for identifying additional required actions and additional optional actions. Additional required actions may be one or more actions that are required in response to the execution of one or more actions to resolve a financial conflict. For example, one or more actions associated with the resolution of a financial conflict associated with inconsistent marital status may also indicate an additional required action of updating a last name (e.g., if a last name is changed due to a marriage).

Additional optional actions may be one or more actions that are optional in response to executing one or more actions or an additional required action. For example, one or more actions associated with the resolution of a financial conflict associated with inconsistent marital status (due to an individual recently getting married) may cause the financial profile analysis engine 210 to suggest one or more common (e.g., frequent) actions typically executed by individuals following a marriage, such as a change in beneficiaries, a change of address, change of name, the addition of a new dependent, or the like.

In some embodiments, the financial profile analysis engine 210 may search a local storage device (e.g., memory 204, storage device 110, or the like) that includes historical data. In some embodiments the historical data may include additional required actions and additional optional actions associated with one or more financial data conflicts. In some embodiments, if local data pertaining to additional required actions and/or additional optional actions are not present, financial profile analysis engine 210 may cause communications hardware 206 to transmit an additional action request via a network (e.g., communications network 104, FIG. 1) to an external computing device (e.g., host device 108A-108N) that describes the financial data conflict and if the particular financial institution associated with the financial data conflict contains data pertaining to additional required actions or additional optional actions. In some embodiments, if the particular financial institution associated with the financial data conflict contains data pertaining to an additional required action or additional optional action, the particular financial institution may transmit the data to the apparatus 200 via a network. Financial profile analysis engine 210 may store the received data and associate the received data with the financial conflict in a local storage device (e.g., memory 204, storage device 110, or the like).

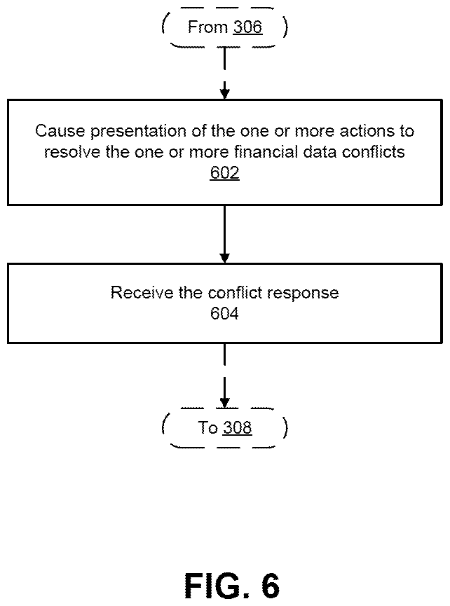

In some embodiments, after accessing historical data to determine one or more actions, additional required actions, and/or additional optional actions to resolve a financial data conflict, the apparatus 200 (e.g., communications hardware 206) the apparatus 200 may transmit a message to a computing device associated with the individual (e.g., a user device 106A) to determine one or more actions to execute, which is described further below in connection to FIG. 6. Turning now to FIG. 6, example operations are shown for determining the one or more actions to execute.

As shown by operation 602, the apparatus 200 includes means, such as processor 202, memory 204, communications hardware 206, financial profile identification engine 208, or the like, for causing presentation of the one or more actions to resolve the one or more financial data conflicts. In some embodiments the apparatus 200 (e.g., communications hardware 206) may transmit an action request to a computing device associated with the individual (e.g., user device 106A-106N) via a network (e.g., communications network 104, FIG. 1). In some embodiments the computing device receiving the action request must be considered a trusted device. In some embodiments, a trusted device dataset may be stored in a local storage device (e.g., memory 204, storage device 110, or the like). The trusted device dataset may store the individual and a trusted device associated with the individual in the form of key-value pairs where the key portion specifies an individual and the value portion specifies a trusted device (e.g., by a device identifier, such as a Media Access Control (MAC) address or the like). Prior to transmitting the action request, financial profile identification engine may determine the trusted device to transmit the action request to by referencing the trusted device dataset.

In some embodiments, the action request may include the identified financial data conflict, one or more actions to resolve the financial data conflict, one or more additional required actions in response to resolving the financial data conflict, one or more additional optional actions in response to resolving the financial data conflict, and/or the like. For example, assume a financial data conflict is associated with the listed marital status, the action request may include one or more actions to update the individual's marital status and one or more optional actions to update the individual's address, beneficiary information, or the like.

In some embodiments, the apparatus 200 (e.g., communications hardware 206) may transmit an action request to a computing device associated with a particular financial institution associated with the financial data conflict (e.g., host device 108A-108N) via a network (e.g., communications network 104, FIG. 1). In some embodiments, the computing device receiving the action request that is considered a trusted device may be a computing device associated with a financial institution.

In some embodiments, financial profile identification engine 208 may search a local storage device (e.g., memory 204, storage device 110, or the like) for a dataset that includes individual action preferences. Individual action preferences may describe if an individual prefers to be queried on a computing device associated with the individual or if the individual prefers the apparatus 200 (e.g., communications hardware 206) first queries the financial institution. In some embodiments, financial profile identification engine 208 may search for individual action preferences in a local storage device prior to transmitting an action request.

As shown by operation 604, the apparatus 200 includes means, such as, processor 202, memory 204, communications hardware 206, or the like, for receiving a conflict response. A conflict response may describe the one or more actions selected (e.g., selected by a financial institution, individual, or the like) to resolve a financial data conflict. In some embodiments, an individual confirming an action to resolve a financial conflict on a computing device (e.g., user device 106A, or the like) may be a conflict response. For example, an individual may confirm on user device 106A to change certain data (e.g., beneficiary, demographic, or the like) at a particular financial institution that is associated with a financial data conflict. In some embodiments, the conflict response may include a digital signature, contain a biometric marker, or the like. The conflict response may include one or more actions associated with the financial data conflict. In some embodiments, the conflict response may include one or more actions associated with one or more additional required actions and/or one or more additional optional actions. In some embodiments the conflict response may be formatted based on the particular financial institution associated with the conflict response.

In some embodiments, a financial institution may provide a conflict response rather than an individual. For example, the apparatus 200 may identify a financial data conflict between a first financial institution and a second financial institution. Assume that the apparatus 200 concluded that the first financial institution has no listed address associated with the individual. The apparatus 200 may provide the listed address at the second financial institution to the first financial institution. The first financial institution may then update the address information to resolve the financial data conflict and transmit a conflict response detailing the updated address information to the apparatus 200.

In some embodiments, the conflict response may include data that indicates the conflict response originated from a trusted device (e.g., user device 106A, host device 108A, or the like). In some embodiments, a trusted device dataset may be stored in a storage device (e.g., memory 204, storage device 110, or the like). In some embodiments, the secure data circuitry 212 may search the trusted device dataset to identify a trusted device associated with an individual transmitted the conflict response. For example, the secure data circuitry 212 may compare the trusted device included in the trusted device dataset to the trusted device included in the conflict response to verify the security of the received conflict response. In an instance in which a trusted device is not included in the conflict response, or the device included in the conflict response is not trusted (e.g., not included in the trusted device dataset) the secure data circuitry 212 may reject the conflict response.

Returning to FIG. 3, as shown by operation 308, the apparatus 200 includes means, such as processor 202, memory 204, communications hardware 206, secure data circuitry 212, or the like, for generating a secured financial update dataset based on the conflict response. In some embodiments, a secured financial update dataset may describe the conflict response based on an update to the first set of financial data or the second set of financial data. In some embodiments, the secured financial update dataset may also be formatted or configured to be associated with the particular financial institution associated with the financial data conflict.

In some embodiments, secure data circuitry 212 may mask the secured financial update dataset. For example, the secured financial update dataset may be generated such that a portion of the data in the conflict response is masked or otherwise omitted. Secure data circuitry 212 may use any data masking techniques to mask a portion of the data in the secured financial update dataset such as scrambling, substitution, date aging, variance, masking out, or the like. In addition, secure data circuitry 212 may implement any type of data masking such as static data masking, dynamic data masking, on-the-fly data masking, or the like. For example, a conflict response associated with updating the beneficiary information associated with a first financial institution may require the beneficiaries name and social security number.

In some embodiments, secure data circuitry 212 may implement a dynamic data masking technique that obscures or blocks access to sensitive information (e.g., personal identifiable information, or the like) in real-time preventing sensitive information from a first financial institution from being displayed to a second financial institution. For example, assume an individual's financial footprint indicates beneficiary data (e.g., name, social security number, etc.) at a first financial institution while at a second financial institution no beneficiary is listed. The secure data circuitry 212 may leverage communications hardware 206 to retrieve beneficiary data associated with the first financial institution, mask the beneficiary data, and transmit the masked beneficiary data to the second financial institution. In some embodiments, the masked beneficiary data may omit the beneficiary's social security number but include the beneficiary's name, which may trigger the second financial institution to prompt the individual to insert beneficiary information associated with the beneficiary data from the first financial institution.

In some embodiments, secure data circuitry 212 may reference a masking dataset stored in a local storage device (memory 204, storage device 110, or the like) or stored in a storage device associated with one or more financial institutions (e.g., leveraging communications hardware 206 to access host device 108A, host device 108N, or the like) to maintain referential integrity across many secured update datasets. For example, the secure data circuitry 212 may reference the masking data set that indicates that the name “Alexander” must always be replaced by the name “Joseph” wherever it occurs in the data to preserve primary and foreign keys and relationships.

Finally, as shown by operation 310, the apparatus 200 includes means, such as processor 202, memory 204, communications hardware 206, financial profile analysis engine 210, secure data circuitry 212, or the like, for transmitting the secured financial update dataset to one or more of the first financial institution and the second financial institution. For example, secure data circuitry 212 may cause communications hardware 206 to transmit the secured financial update dataset to the first financial institution. In some embodiments, secure data circuitry may retrieve the secured financial update dataset from a storage device (memory 204, storage device 110, or the like). In some embodiments, the secured financial update dataset may be transmitted by the apparatus 200 via a network (communications network 104, FIG. 1) to a host device associated with the financial institution receiving the secured financial update dataset (e.g., the first financial institution.

In some embodiments, following the transmission of the secured financial update data set, financial profile analysis engine 210 may generate a financial profile update report based on the secured financial update dataset. The financial profile update report may describe the conflict response and receipt of the completed update to the financial profile associated with the financial data conflict. The financial profile update report may be customized to suit a particular style desired by an individual. In some embodiments, the financial profile update report may be generated according to a formatted output, for example as a webpage comprising visual representations of any changes to the individual's financial profiles associated with a financial institution. In some embodiments, the financial profile update report may be a message delivered to the individual as a receipt documenting the execution of a conflict response. For example, financial profile analysis engine 210 may cause communications hardware 206 to cause delivery of the financial profile update report to a trusted device associated with the individual (e.g., user device 106A, or the like) via a network (e.g., communications network 104, FIG. 1).

FIGS. 3, 4, 5, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

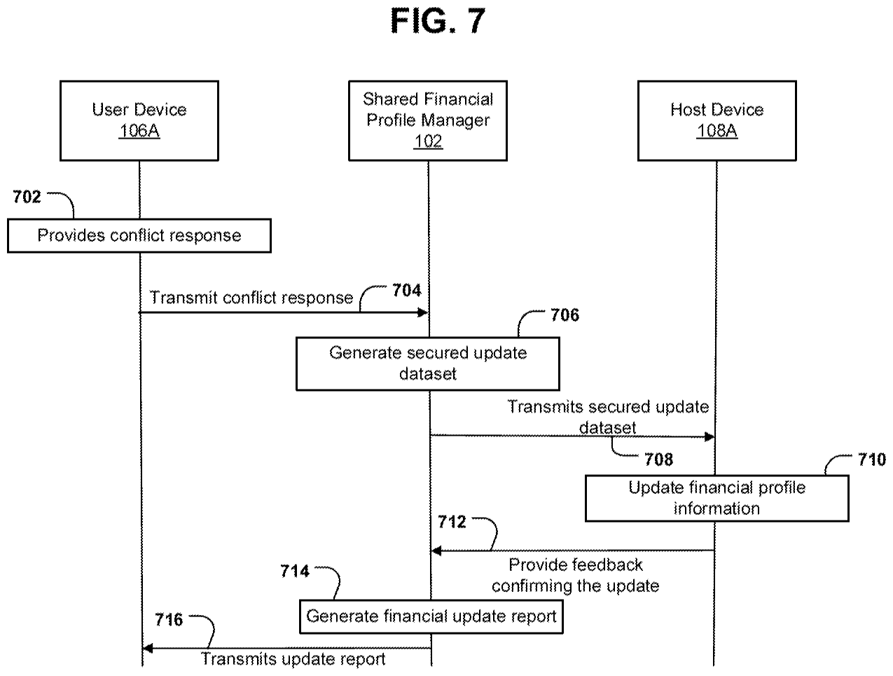

FIG. 7 shows a swim lane diagram illustrating example operations (e.g., as described above in connection with FIGS. 4-6) performed by components of the environment depicted in FIG. 1 to produce various benefits of the implementations described herein. The operations shown in the swim lane diagram performed by user device 106A are shown along the line extending from the box labeled “user device 106A,” operations performed by a shared financial profile manager 102 are shown along the line extending from the box labeled “shared financial profile manager 102,” and operations performed by a host device associated with a financial institution are shown along the line extending from the box labeled “host device 108A.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIG. 7.

At operation 702, an individual may select a conflict response to resolve a financial data conflict on a user device 106A. At operation 704, user device 106A may provide the shared financial profile manager 102 the previously selected conflict response (e.g., operation 702). At operation 706, shared financial profile manager 102 may generate a secured update dataset that is based on the received conflict response. In addition, the secured update dataset may be generated and formatted to align with requirements described with host device 108A. At operation 708 the shared financial profile manager 102 may transmit the generated secured update data set to host device 108A (e.g., a computing device associated with the financial institution associated with the conflict response). At operation 710, host device 108A may update financial profile information based on the received secured update dataset. At operation 712, host device 108A may transmit data to shared financial profile manager 102 providing feedback confirming the update to the financial profile based on the received secured update dataset. At operation 714, shared financial profile manager may generated a financial update report based on the received confirmation (e.g., operation 712). At operation 716, the shared financial profile manager 102 may provide the user device 106A the generated financial update report.

In some embodiments, some of the operations described above in connection with FIGS. 4-7 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved ability to update information across a consortium of banks associated with an individual. Example embodiments thus provide tools that overcome the problems faced by individuals and entities. By avoiding the need to manually update information associated with an individual's financial profile, example embodiments thus save time and resources, while also eliminating the possibility of human error that has been unavoidable in the past. Moreover, embodiments described herein avoid difficulties associated with communicating information across a consortium of banks. Finally, by automating functionality that has historically required human analysis, the speed and consistency of the evaluations performed by example embodiments unlocks many potential new functions that have historically not been available, such as the ability to conduct near-real-time analysis of an individual's financial profile and detect inconsistencies therein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for sharing financial profiles, the method comprising:
determining, by a financial profile identification engine, a financial footprint of an individual, wherein the financial footprint comprises a first set of financial data about the individual from a first financial institution and a second set of financial data about the individual from a second financial institution;
analyzing, by a financial profile analysis engine, the financial footprint of the individual to identify a financial data conflict between the first set of financial data and the second set of financial data;
determining, by the financial profile analysis engine, one or more actions to resolve the financial data conflict;
generating, by secure data circuitry, a secured financial update dataset based on a conflict response; and
transmitting, by communications hardware, the secured financial update dataset to one or more of the first financial institution and the second financial institution.

2. The method of claim 1, further comprising:
causing, by communications hardware, presentation of the one or more actions to resolve the financial data conflict; and
in response to presentation of the one or more actions, receiving a conflict response.

3. The method of claim 2, wherein the presentation of the one or more actions occurs on a trusted device.

4. The method of claim 1, further comprising:
receiving, by the communications hardware, a financial footprint request associated with the individual,
wherein determining the financial footprint of the individual occurs in response to receiving the financial footprint request.

5. The method of claim 1, further comprising:
transmitting, by the communications hardware, a data aggregation request to one or more financial institutions, and
receiving, by the communications hardware, a plurality of financial data associated with the one or more financial institutions.

6. The method of claim 1, further comprising:
identifying, by the financial profile analysis engine, an additional required action based on resolution of the financial data conflict.

7. The method of claim 6, wherein identifying the additional required action comprises:
accessing, by the financial profile identification engine, historical data comprising a plurality of resolved financial data conflicts; and
identifying, by a financial profile identification engine, the additional required action based on the historical data.

8. The method of claim 1, further comprising:
generating, by the financial profile analysis engine, one or more additional optional actions based on the conflict response.

9. The method of claim 1, wherein generating the conflict response associated with the individual further comprises:
determining, by the financial profile analysis engine, whether the first financial institution and the second financial institution require updated data,
wherein a secured financial update dataset is transmitted to each financial institution requiring updated data.

10. The method of claim 1, further comprising:
in response to transmitting the secured financial update dataset, generating, by the financial profile analysis engine, a financial profile update report based on the secured financial update dataset; and
causing, by the communications hardware, delivery of the financial profile update report to the individual.

11. The method of claim 1, wherein the secured financial update dataset masks a portion of data in the conflict response.

12. An apparatus for sharing financial profiles, the apparatus comprising:
financial profile identification engine configured to determine a financial footprint of an individual, wherein the financial footprint comprises a first set of financial data about the individual from a first financial institution and a second set of financial data about the individual from a second financial institution;
financial profile analysis engine configured to:
analyze the financial footprint of the individual to identify a financial data conflict between the first set of financial data and the second set of financial data; and
determine one or more actions to resolve the financial data conflict;
secure data circuitry configured to generate a secured financial update dataset based on a conflict response; and
communications hardware configured to transmit the secured financial update dataset to one or more of the first financial institution and the second financial institution.

13. The apparatus of claim 12, wherein the communications hardware is further configured to:
receive a financial footprint request associated with the individual,
wherein determining the financial footprint of the individual occurs in response to receiving the financial footprint request.

14. The apparatus of claim 12, wherein the communications hardware is further configured to:
transmit a data aggregation request to one or more financial institutions, and
receive a plurality of financial data associated with the one or more financial institutions.

15. The apparatus of claim 12, wherein the financial profile analysis engine is further configured to:
identify an additional required action based on resolution of the financial data conflict.

16. The apparatus of claim 15, wherein the financial profile identification engine is further configured to:
access historical data comprising a plurality of resolved financial data conflicts; and
identify the additional required action based on the historical data.

17. A non-transitory computer-readable storage medium storing instructions that, when executed by an apparatus, cause the apparatus to:
determine a financial footprint of an individual, wherein the financial footprint comprises a first set of financial data about the individual from a first financial institution and a second set of financial data about the individual from a second financial institution;
analyze the financial footprint of the individual to identify a financial data conflict between the first set of financial data and the second set of financial data;
determine one or more actions to resolve the financial data conflict;
generate a secured financial update dataset based on a conflict response; and
transmit the secured financial update dataset to one or more of the first financial institution and the second financial institution.

18. The non-transitory computer-readable storage medium of claim 17, wherein the instructions, when executed by the apparatus, further cause the apparatus to:
receive a financial footprint request associated with the individual,
wherein determining the financial footprint of the individual occurs in response to receiving the financial footprint request.

19. The non-transitory computer-readable storage medium of claim 17, wherein the instructions, when executed by the apparatus, further cause the apparatus to:
transmit a data aggregation request to one or more financial institutions, and
receive a plurality of financial data associated with the one or more financial institutions.

20. The non-transitory computer-readable storage medium of claim 17, wherein the instructions, when executed by the apparatus, further cause the apparatus to:
identify an additional required action based on resolution of the financial data conflict.
